(19) United States
(12) Patent Application Publication
(10) Pub. No.: US 2023/0249716 A1
(43) Pub. Date: Aug. 10, 2023

(54) VEHICLE, CONTROL DEVICE AND CONTROL METHOD THEREFOR

(71) Applicant: HONDA MOTOR CO., LTD., Tokyo (JP)

(72) Inventors: Chihiro OGURO, Wako-shi (JP); Junya YODA, Wako-shi (JP); Hirofumi KANAZAKI, Wako-shi (JP); Ryo KASHIMOTO, Wako-shi (JP); Yosuke NAGAMATSU, Tokyo (JP)

(21) Appl. No.: 18/095,591

(22) Filed: Jan. 11, 2023

(30) Foreign Application Priority Data
Feb. 7, 2022 (JP) 2022-017179

(51) Int. Cl. B60W 60/00; B60W 40/105; B60W 40/06; B60W 40/04; B60W 30/165; B60W 50/00

(52) U.S. Cl. CPC B60W 60/0051; B60W 40/105; B60W 40/06; B60W 40/04; B60W 30/165; B60W 50/0097; B60W 2556/10

(57) ABSTRACT

A control device for a vehicle includes a recognition unit configured to recognize an environment around the vehicle, a travel control unit configured to control traveling of the vehicle based on the environment recognized by the recognition unit, and a prediction unit configured to predict how long a low-speed state in which a speed of the vehicle is lower than a low-speed threshold will continue. The travel control unit determines, based on a prediction result by the prediction unit, whether to transition from a first traveling state to a second traveling state, a driver of the vehicle being less involved in the second traveling state than in the first traveling state.

### CROSS-REFERENCE TO RELATED APPLICATION(S)

This application claims priority to and the benefit of Japanese Patent Application No. 2022-017179 filed on Feb. 7, 2022, the entire disclosure of which is incorporated herein by reference.

### BACKGROUND OF THE INVENTION

### Field of the Invention

The present invention relates to a vehicle, a control device and a control method therefor.

### Description of the Related Art

A vehicle capable of conducting traffic jam follow-up control has been proposed. The traffic jam follow-up control denotes an operation in which a control device of a vehicle controls traveling of the vehicle so that the vehicle automatically follows a preceding vehicle while maintaining a safe inter-vehicle distance from the preceding vehicle within a range equal to or lower than a predetermined vehicle speed. Japanese Patent No. 6932209 discloses a technique for automatically starting the traffic jam follow-up control in accordance with the speed of a preceding vehicle. Cases where the speed of a vehicle decreases are not limited to a case where a traffic jam occurs in an advancing direction of the vehicle, but can include a case where the vehicle speed temporarily decreases because of waiting for a traffic light to change, for example. When the traffic jam follow-up control is started in such a case where the vehicle speed temporarily decreases, the traffic jam follow-up control will immediately end in response to an increase in the vehicle speed. The traveling state controlled by the vehicle frequently switching in this manner may make the driver feel annoyed.

### SUMMARY OF THE INVENTION

According to an aspect of the present disclosure, an excessive change in the traveling state of the vehicle is suppressed. According to some embodiments, there is provided a control device for a vehicle, the control device comprising: a recognition unit configured to recognize an environment around the vehicle; a travel control unit configured to control traveling of the vehicle based on the environment recognized by the recognition unit; and a prediction unit configured to predict how long a low-speed state in which a speed of the vehicle is lower than a low-speed threshold will continue, wherein the travel control unit determines, based on a prediction result by the prediction unit, whether to transition from a first traveling state to a second traveling state, a driver of the vehicle being less involved in the second traveling state than in the first traveling state.

### BRIEF DESCRIPTION OF THE DRAWINGS

FIG. 1 is a block diagram for describing a hardware configuration example of a vehicle according to some embodiments;

FIG. 2 is a block diagram for describing a functional configuration example of the vehicle according to some embodiments;

FIGS. 3A and 3B are schematic diagrams for describing an occurrence factor of a low-speed state according to some embodiments;

FIG. 4 is a graph for describing an example of a method for determining a transition threshold according to some embodiments; and

FIG. 5 is a flowchart for describing an example of a vehicle control method according to some embodiments.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

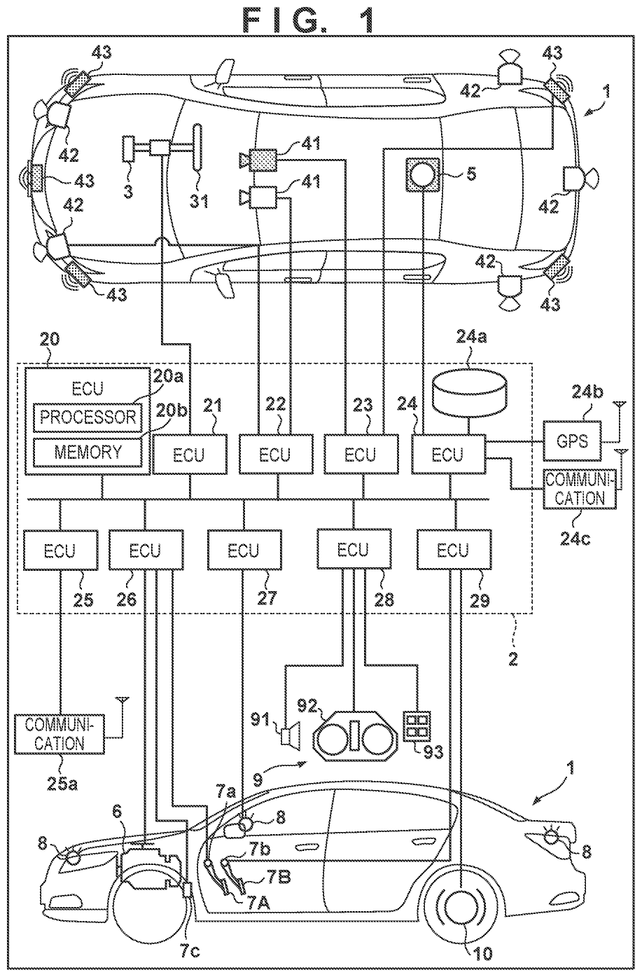

FIG. 1 is a block diagram of a vehicle 1 according to one embodiment of the present invention. In FIG. 1, the vehicle 1 is schematically illustrated in a plan view and in a side view. The vehicle 1 is, for example, a sedan-type four-wheeled passenger vehicle. The vehicle 1 may be such a four-wheeled vehicle, a two-wheeled vehicle, or another type of vehicle.

The vehicle 1 includes a vehicle control device 2 (hereinafter, simply referred to as a control device 2) that controls the vehicle 1. The control device 2 includes a plurality of electronic control units (ECUs) 20 to 29 communicably connected through an in-vehicle network. Each ECU includes a processor represented by a central processing unit (CPU), a memory such as a semiconductor memory, an interface with an external device, and the like. The memory stores a program to be executed by the processor, data used for processing by the processor, and the like. Each ECU may include a plurality of processors, memories, interfaces, and the like. For example, the ECU 20 includes a processor 20a and a memory 20b. The processor 20a executes a command included in a program stored in the memory 20b, and the ECU 20 executes processing. Alternatively, the ECU 20 may include a dedicated integrated circuit such as an application specific integrated circuit (ASIC) or a field programmable gate array (FPGA) for causing the ECU 20 to execute processing. A similar configuration applies to the other ECUs.

Hereinafter, functions and the like assigned to the ECUs 20 to 29 will be described. Note that the number of ECUs and functions to be assigned can be designed as appropriate, and can be subdivided or integrated as compared with the present embodiment.

The ECU 20 conducts control related to automated traveling of the vehicle 1. For automated driving, at least one of steering and acceleration/deceleration of the vehicle 1 is automatically controlled. The automated traveling by the ECU 20 may include automated traveling that does not require a traveling operation by the driver of the vehicle 1 (hereinafter, simply referred to as a driver) (may also be referred to as automated driving) and automated traveling for assisting the traveling operation by the driver (may also be referred to as driving assistance).

The ECU 21 controls an electric power steering device 3. The electric power steering device 3 includes a mechanism that steers front wheels in accordance with a driving operation (steering operation) given to a steering wheel 31 by a driver. The electric power steering device 3 includes a motor that produces driving force for assisting the steering operation and automatically steering the front wheels, a sensor that detects a steering angle, and the like. In a case where the driving state of the vehicle 1 is the automated driving, the ECU 21 controls the electric power steering device 3 in an automated manner in response to an instruction from the ECU 20, and controls the advancing direction of the vehicle 1.

The ECUs 22 and 23 conduct control of detection units 41 to 43 that detects situations around the vehicle 1, and perform information processing of detection results. The detection unit 41 (hereinafter, referred to as a camera 41, in some cases) is a camera that captures an image of a forward side of the vehicle 1, and is attached to a vehicle interior side of a windshield at a front side of a roof of the vehicle 1 in the present embodiment. By analyzing the image that has been captured by the camera 41, it is possible to extract an outline of a target or a lane division line (white line or the like) of a traffic lane on a road.

The detection unit 42 is a light detection and ranging (hereinafter, referred to as a LiDAR 42, in some cases), and detects a target in the surroundings of the vehicle 1, and measures a distance to a target object. In the present embodiment, five LiDARs 42 are provided, including one at each corner portion of a front part of the vehicle 1, one at the center of a rear part of the vehicle 1, and one at each lateral side of the rear part of the vehicle 1. The detection unit 43 is a millimeter wave radar (hereinafter, referred to as a radar 43, in some cases), and detects a target object in the surroundings of the vehicle 1 and measures a distance to the target object. In the present embodiment, five radars 43 are provided, including one at the center of the front part of the vehicle 1, one at each corner portion of the front part of the vehicle 1, and one at each corner portion of the rear part of the vehicle 1.

The ECU 22 controls one camera 41 and each LiDAR 42, and performs information processing of detection results. The ECU 23 controls the other camera 41 and each radar 43, and performs information processing on detection results. Two sets of devices for detecting situations around the vehicle 1 are provided, so that the reliability of the detection results can be improved. Different types of detection units such as a camera, a LiDAR, and a radar are provided, so that the environment around the vehicle 1 can be analyzed in multiple manners.

The ECU 24 controls the gyro sensor 5, a global navigation satellite system (GNSS) sensor 24b, and a communication device 24c, and performs information processing of detection results or communication results. The gyro sensor 5 detects a rotational movement of the vehicle 1. It is possible to determine the course of the vehicle 1 based on a detection result of the gyro sensor 5, the wheel speed, and the like. The GNSS sensor 24b detects a current location of the vehicle 1. The communication device 24c performs wireless communication with a server that provides map information and traffic information, and acquires these pieces of information. The ECU 24 is capable of accessing a database 24a in which map information is stored, and the ECU 24 searches for a route from a current location to a destination. The ECU 24, the database 24a, and the GNSS sensor 24b constitute a so-called navigation device.

The ECU 25 includes a communication device 25a for inter-vehicle communication. The communication device 25a performs wireless communication with another vehicle in the surroundings to exchange information between the vehicles.

The ECU 26 controls a power plant 6. The power plant 6 is a mechanism that outputs driving force for rotating driving wheels of the vehicle 1, and includes, for example, an engine and a transmission. For example, the ECU 26 controls an output of the engine in response to a driving operation (accelerator operation or acceleration operation) of the driver that has been detected by an operation detection sensor 7a provided on an accelerator pedal 7A, and switches the gear ratio of the transmission based on information such as a vehicle speed that has been detected by a vehicle speed sensor 7c and the like. In a case where the driving state of the vehicle 1 is the automated driving, the ECU 26 controls the power plant 6 in an automated manner in response to an instruction from the ECU 20, and controls the acceleration or deceleration of the vehicle 1.

The ECU 27 controls lighting devices (headlights, taillights, and the like) including direction indicators 8 (blinkers). In the example of FIG. 1, the direction indicator 8 is provided on front parts, door mirrors, and rear parts of the vehicle 1.

The ECU 28 controls an input and output device 9. The input and output device 9 outputs information to the driver, and receives information input from the driver. A sound output device 91 notifies the driver of information by a sound. A display device 92 notifies the driver of information by displaying an image. The display device 92 is disposed, for example, in front of a driver's seat, and constitutes an instrument panel, for example. Note that, although the sound and the display have been given as examples here, information may be notified by vibration or light. In addition, information may be notified by a combination from among sound, display, vibration, and light. Furthermore, the combination or the form of notification may be changed in accordance with the level (for example, the degree of urgency) of information to be notified. An input device 93 is a group of switches disposed at positions where the driver is able to operate them, and is used for giving an instruction to the vehicle 1, but may also include a voice input device.

The ECU 29 controls a brake device 10 and a parking brake (not illustrated). The brake device 10 is, for example, a disc brake device, is provided on each wheel of the vehicle 1, and applies resistance against a rotation of the wheel to decelerate or stop the vehicle 1. The ECU 29 controls operations of the brake device 10 in response to a driving operation (braking operation) performed by the driver and detected by an operation detection sensor 7b provided on a brake pedal 7B, for example. In a case where a driving state of the vehicle 1 is the automated driving, the ECU 29 automatically controls the brake device 10 in response to an instruction from the ECU 20, and controls the deceleration and stopping of the vehicle 1. It is also possible to operate the brake device 10 and the parking brake to keep the vehicle 1 in a stopped state. In a case where the transmission of the power plant 6 includes a parking lock mechanism, it is also possible to operate the parking lock mechanism to keep the vehicle 1 in a stopped state.

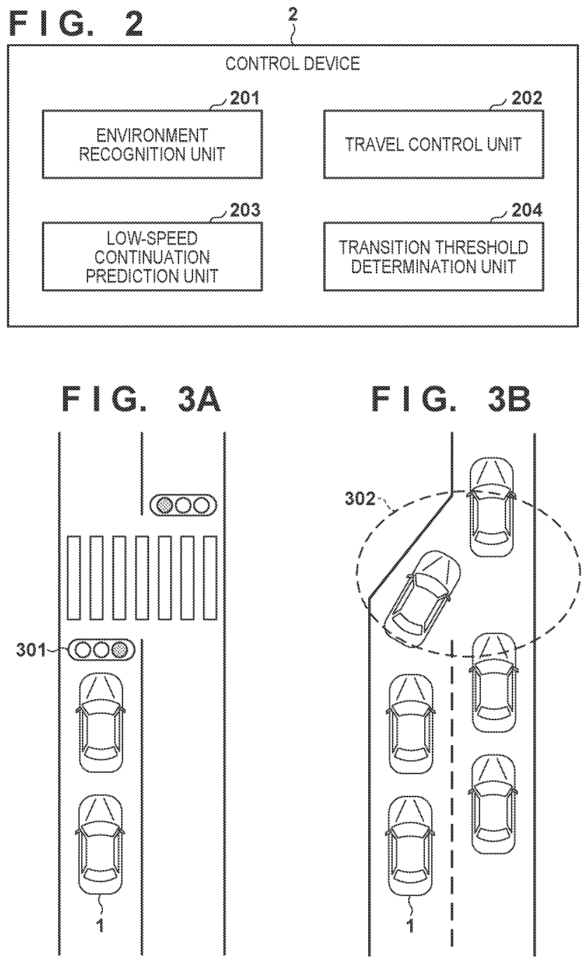

A functional configuration example of the control device 2 of the vehicle 1 will be described with reference to FIG. 2. The control device 2 includes a plurality of functional blocks illustrated in FIG. 2. FIG. 2 illustrates only functional blocks used for describing various embodiments of the present invention. The control device 2 may include another functional block that is not illustrated in FIG. 2. In addition, in some embodiments, the control device 2 does not have to include a part of the functional blocks illustrated in FIG. 2. The operation by the functional blocks of the control device 2 may be achieved by the processor 20a executing a program that has been read into the memory 20b. Alternatively, the operations of some or all of the functional blocks of the control device 2 may be achieved by a dedicated circuit such as an ASIC or an FPGA.

An environment recognition unit 201 recognizes an environment in the surroundings of the vehicle 1. The surroundings of the vehicle 1 may denote a range where an object that provides information to be used by a travel control unit 202 and a low-speed continuation prediction unit 203 in processing to be described later is present. For example, the surroundings of the vehicle 1 may include a range detectable by the detection units 41 to 43. In addition, the surroundings of the vehicle 1 may include a range where the vehicle 1 is capable of conducting inter-vehicle communication using the communication device 25a. The environment in the surroundings of the vehicle 1 may denote a state of the object that provides information to be used by the travel control unit 202 and the low-speed continuation prediction unit 203 in the processing to be described later. For example, the environments in the surroundings of the vehicle 1 may include road structures (the location of a division line, the location of an intersection, the location of a traffic signal, the numbers of traffic lanes, and the like) around the vehicle 1, and states (a location, a size, a moving speed, a moving direction, and the like) of traffic participants (for example, other vehicles and pedestrians) other than the vehicle 1.

The environment recognition unit 201 may use various types of information to recognize the environment in the surroundings of the vehicle 1. The information to be used by the environment recognition unit 201 may include detection results (for example, images around the vehicle 1) by the detection units 41 to 43. Further, the information to be used by the environment recognition unit 201 may include a current location of the vehicle 1 that has been measured by the GNSS sensor 24b and map information that has been read from the database 24a. Furthermore, the information to be used by the environment recognition unit 201 may include information (for example, a location, a speed, a moving direction, and the like of another vehicle) that has been received from another vehicle by use of the communication device 25a. Furthermore, the information to be used by the environment recognition unit 201 may include traffic information in the surroundings of the vehicle 1 that has been distributed from a server.

The travel control unit 202 controls traveling of the vehicle 1 based on the environment in the surroundings of the vehicle 1 recognized by the environment recognition unit 201. For example, the travel control unit 202 may control the traveling of the vehicle 1 by controlling driving, braking, and steering of the vehicle 1 in an automated manner, without necessitating an operation by the driver (that is, regardless of the operation of the driver). Such control in the traveling of the vehicle 1 without necessitating the driver's operation will be hereinafter referred to as automated travel control.

The travel control unit 202 may be capable of conducting the automated travel control by switching between a plurality of traveling states. For example, the traveling states enabled by the travel control unit 202 may include a traveling state in which the driver has to grip the steering wheel 31 and has to monitor the surroundings, and a traveling state in which the driver does not have to grip the steering wheel 31 but has to monitor the surroundings. The traveling state in which the driver has to grip the steering wheel 31 and has to monitor the surroundings will be hereinafter referred to as a hands-on traveling state. The traveling state in which the driver does not have to grip the steering wheel 31 but has to monitor the surroundings will be hereinafter referred to as a hands-off traveling state. In the hands-off traveling state, the driver is less involved in the traveling of the vehicle 1 than in the hands-on traveling state. In other words, the hands-off traveling state is higher in automated rate than the hands-on traveling state.

Conditions for the travel control unit 202 to conduct the hands-off traveling state may include the vehicle 1 being capable of following a preceding vehicle of the vehicle 1. For example, when a distance between the vehicle 1 and a vehicle traveling on a forward side of the vehicle 1 in the same traffic lane with the vehicle 1 falls within a threshold distance (for example, within 30 meters), the travel control unit 202 may determine that the vehicle 1 is capable of following the preceding vehicle. In a case where such a condition is imposed, the travel control unit 202 conducting the hands-off traveling state follows the preceding vehicle of the vehicle 1. The travel control unit 202 may transition from the hands-off traveling state to the hands-on traveling state, when it becomes impossible to follow the preceding vehicle of the vehicle 1.

The traveling state enabled by the travel control unit 202 may include a traveling state in which the driver neither has to grip the steering wheel 31 nor monitor the surroundings. A traveling state in which the driver neither has to grip the steering wheel 31 nor monitor the surroundings will be hereinafter referred to as an eyes-off traveling state. In the eyes-off traveling state, the driver is less involved in the traveling of the vehicle 1 than in the hands-off traveling state.

While conducting the automated travel control, the travel control unit 202 selects a traveling state to be enabled from a plurality of traveling states, based on an environment in the surroundings of the vehicle 1, and controls the traveling of the vehicle 1 in the selected traveling state. For example, the travel control unit 202 may transition from the hands-on traveling state to the hands-off traveling state based on an environment having made the hands-off traveling state operable while the hands-on traveling state is operating. In addition, the travel control unit 202 may transition from the hands-off traveling state to the hands-on traveling state based on an environment having made the hands-off traveling state inoperable while the hands-off traveling state is operating.

Conditions for transitioning from the hands-on traveling state to the hands-off traveling state will be described. The travel control unit 202 may transition from the hands-on traveling state to the hands-off traveling state based on the vehicle speed having become lower than a specific threshold. Such a threshold will be hereinafter referred to as a transition threshold. When the transition from the hands-on traveling state to the hands-off traveling state is conducted based on only a comparison between the vehicle speed and the transition threshold, a situation to be described below may occur.

For example, as illustrated in FIG. 3A, it is assumed that the vehicle 1 stops in response to a red signal of a traffic light 301 located in an advancing direction of the vehicle 1. In this case, the vehicle speed is lower than the transition threshold (for example, 30 km/h). In response to this, it is assumed that the travel control unit 202 transitions from the hands-on traveling state to the hands-off traveling state. Then, it is assumed that the vehicle 1 restarts traveling in response to the traffic light 301 turning to a green light, and the vehicle speed exceeds the transition threshold (for example, 30 km/h). In response to this, the travel control unit 202 transitions from the hands-off traveling state to the hands-on traveling state. Switching between the hands-off traveling state and the hands-on traveling state in such a short period of time may make the driver feel annoyed.

On the other hand, as illustrated in FIG. 3B, it is assumed that the number of traffic lanes decreases in a place 302 located in the advancing direction of the vehicle 1. In this case, the speed of the vehicle 1 having become lower is highly possibly caused by an occurrence of a traffic jam in the advancing direction of the vehicle 1. In this case, even though the traveling state transitions from the hands-on traveling state to the hands-off traveling state, there is a low possibility that the traveling state returns to the hands-on traveling state in a short period of time. Therefore, in some embodiments, the travel control unit 202 determines whether to transition from the hands-on traveling state to the hands-off traveling state based on not only the speed of the vehicle 1 having become low but also a prediction result of how long such a low-speed state will continue. Accordingly, an excessive change between the hands-on traveling state and the hands-off traveling state is suppressed.

The low-speed continuation prediction unit 203 predicts how long the state in which the speed of the vehicle 1 is low will continue, after the speed of the vehicle 1 becomes low. The speed of the vehicle 1 being low may denote that the speed of the vehicle 1 (hereinafter, simply referred to as a vehicle speed) is lower than a threshold. This threshold will be referred to as a low-speed threshold. In addition, a state in which the speed of the vehicle 1 is low will be referred to as a low-speed state. A prediction result of how long the low-speed state will continue may be represented by a period of time, or may be represented by a distance. For example, the prediction result by the low-speed continuation prediction unit 203 may be a prediction that the low-speed state will continue for a specific period of time (for example, 15 minutes), or a prediction that the low-speed state will continue for a specific distance (for example, 2 km). Hereinafter, a case where the prediction result by the low-speed continuation prediction unit 203 is represented by a period of time will be described. However, the following description is also applied to a case where the prediction result by the low-speed continuation prediction unit 203 is represented by a distance, in a similar manner.

The prediction result by the low-speed continuation prediction unit 203 may be represented by two stages (that is, whether the low-speed state will continue for a relatively long period of time or for a relatively short period of time), may be represented by three or more stages, or may be represented by a specific period of time (for example, 15 minutes).

The low-speed continuation prediction unit 203 may predict a duration time of the low-speed state based on various types of information. The information to be used by the low-speed continuation prediction unit 203 may include, for example, a road structure (for example, the number of traffic lanes, the curvature of a road, the frequency of a traffic light, and a traffic sign) in the advancing direction of the vehicle 1. For example, in a case where the number of traffic lanes decreases in the advancing direction of the vehicle 1, the curvature of the road increases, the traffic signal is frequently present, or the speed restriction is imposed by a traffic sign, there is a possibility that a traffic jam is occurring on a forward side of the vehicle 1. Therefore, in a case where the road structure in the advancing direction of the vehicle 1 satisfies such a condition, the low-speed continuation prediction unit 203 may determine that the low-speed state will continue for a relatively long period of time. On the other hand, in a case where there is no structure that induces a traffic jam in the road structure in the advancing direction of the vehicle 1, the low-speed continuation prediction unit 203 may determine that the low-speed state will continue for a relatively short period of time.

The information to be used by the low-speed continuation prediction unit 203 may include traffic information in the past in the advancing direction of the vehicle 1. Such traffic information may be acquired, for example, by being received from an external server. For example, it is assumed that a traffic jam has frequently occurred in the past in a section located in the advancing direction of the vehicle 1. In such a case, the low-speed continuation prediction unit 203 may determine that the low-speed state will continue for a relatively long period of time. On the other hand, in a case where the traffic jam has hardly occurred in the past in the section located in the advancing direction of the vehicle 1, the low-speed continuation prediction unit 203 may determine that the low-speed state will continue for a relatively short period of time.

The low-speed continuation prediction unit 203 may use a traffic state in the past in consideration of a time of day. For example, it is assumed that a traffic jam is likely to occur in a section located in the advancing direction of the vehicle 1 in a specific time zone (for example, from 17:00 to 18:00) but is less likely to occur in the other time zones. In such a case and in a case where the time when the vehicle is predicted to pass through the section is included in such a specific time zone, the low-speed continuation prediction unit 203 may determine that the low-speed state will continue for a relatively long period of time, and in the other cases, the low-speed continuation prediction unit 203 may determine that the low-speed state will continue for a relatively short period time.

The information to be used by the low-speed continuation prediction unit 203 may include an actually occurring situation of a traffic jam. The low-speed continuation prediction unit 203 may determine whether a traffic jam is occurring in the advancing direction of the vehicle 1 based on information that has been received on the inter-vehicle communication or the traffic information that has been received from the server. In a case where a traffic jam is occurring, the low-speed continuation prediction unit 203 may determine that the low-speed state will continue for a relatively long period of time, and in the other cases, the low-speed continuation prediction unit 203 may determine that the low-speed state will continue for a relatively short period of time.

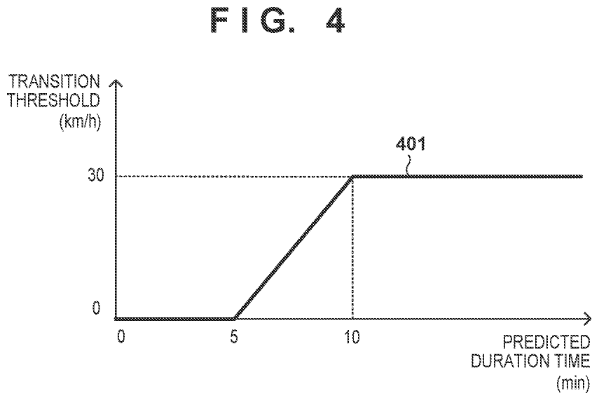

A transition threshold determination unit 204 determines a threshold for causing the traveling state of the vehicle 1 to transition. Determining whether to transition from the hands-on traveling state to the hands-off traveling state based on a predicted duration time of the low-speed state may include determining a transition threshold based on the predicted duration time of the low-speed state. For example, the transition threshold determination unit 204 may determine the transition threshold in accordance with a graph 401 illustrated in FIG. 4. The horizontal axis of the graph 401 indicates the duration time of the low-speed state that has been predicted by the low-speed continuation prediction unit 203. The vertical axis of the graph 401 indicates the transition threshold.

As illustrated in the graph 401, in a case where the predicted duration time is a relatively short period of time (for example, five minutes or shorter), the transition threshold determination unit 204 sets the transition threshold to 0 km/h. In this case, since the vehicle speed is not lower than the transition threshold, the travel control unit 202 does not transition from the hands-on traveling state to the hands-off traveling state. On the other hand, in a case where the predicted duration time is a relatively long period of time (for example, ten minutes or longer), the transition threshold determination unit 204 sets the transition threshold to a positive value (for example, 30 km/h). In this case, the travel control unit 202 transitions from the hands-on traveling state to the hands-off traveling state based on the vehicle speed having become lower than the transition threshold (30 km/h). On the other hand, the travel control unit 202 maintains the hands-on traveling state based on the vehicle speed being not lower than the transition threshold (30 km/h). In a case where the predicted duration time is a medium period of time (for example, five minutes to ten minutes), the transition threshold may change continuously. The graph 401 indicates a non-decreasing function. For this reason, as the predicted duration time becomes longer, it is easier to transition from the hands-on traveling state to the hands-off traveling state.

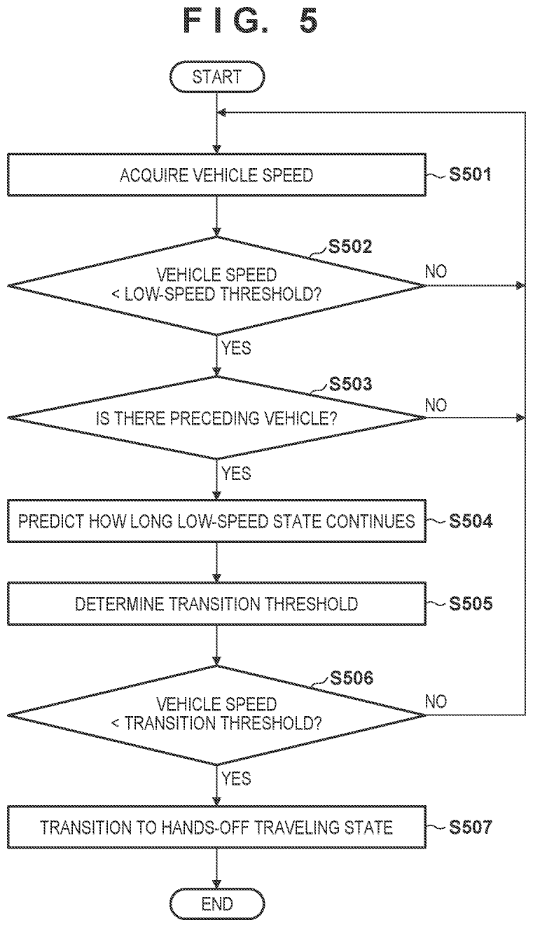

A control method for the vehicle 1 to be performed by the control device 2 will be described with reference to FIG. 5. This method may be started when the control device 2 starts hands-on travel control. Each step of this method may be performed by the processor 20a executing a program that has been read into the memory 20b.

In step S501, the control device 2 (for example, the travel control unit 202) acquires a vehicle speed. The vehicle speed may be acquired by use of a wheel speed sensor of the vehicle 1.

In step S502, the control device 2 (for example, the travel control unit 202) determines whether the vehicle speed is lower than a low-speed threshold. In a case where it is determined that the vehicle speed is lower than the low-speed threshold (“YES” in step S502), the control device 2 moves the processing to step S503, and in the other cases (“NO” in step S502), the control device 2 returns the processing to step S501. The low-speed threshold may be set beforehand and stored in a storage device (for example, the memory 20b) of the vehicle 1. The low-speed threshold may be, for example, 30 km/h. The low-speed threshold may be changed in accordance with an environment around the vehicle 1. The low-speed threshold may be the same value with an upper limit of the transition threshold indicated in the graph 401.

In step S503, the control device 2 (for example, the travel control unit 202) determines whether a preceding vehicle is present on a forward side of the vehicle 1. In a case where it is determined that there is a preceding vehicle (“YES” in step S503), the control device 2 moves the processing to step S504, and in the other cases (“NO” in step S503), the control device 2 returns the processing to step S501. For example, while another vehicle is traveling on a forward side of the vehicle 1 and the distance to such another vehicle falls within a threshold distance (for example, 30 meters), the presence of a preceding vehicle may be determined.

In step S504, the control device 2 (for example, the low-speed continuation prediction unit 203) predicts how long the low-speed state will continue. Since the details of the prediction processing have been described above, overlapping descriptions will be omitted. In step S505, the control device 2 (for example, the transition threshold determination unit 204) determines a transition threshold based on a prediction result in step S504. Since the details of the determination processing have been described above, overlapping descriptions will be omitted.

In step S506, the control device 2 (for example, the travel control unit 202) determines whether the vehicle speed is lower than the transition threshold. In a case where it is determined that the vehicle speed is lower than the transition threshold (“YES” in step S506), the control device 2 moves the processing to step S507, and in the other cases (“NO” in step S506), the control device 2 returns the processing to step S501. In step S507, the control device 2 (for example, the travel control unit 202) transitions from the hands-on traveling state to the hands-off traveling state.

In the above-described method, in a case where all the conditions of steps S502, S503, and S506 are satisfied, the control device 2 transitions from the hands-on traveling state to the hands-off traveling state. The conditions for transitioning from the hands-on traveling state to the hands-off traveling state may include any condition other than the conditions of steps S502, S503, and S506.

In the above-described method, the conditions for transitioning from the hands-on traveling state to the hands-off traveling state include the condition of S503 (that is, the presence of a preceding vehicle). In a case where the control device 2 enables the hands-off traveling state without the presence of a preceding vehicle, the conditions for transitioning from the hands-on traveling state to the hands-off traveling state do not have to include the condition of S503.

In the above-described method, the processing of step S503 and later steps is performed based on the vehicle speed having become lower than the low-speed threshold in step S502. Alternatively or additionally, the processing of step S503 and later steps may be performed in response to an instruction from the driver.

In the above-described embodiments, whether to transition from the hands-on traveling state to the hands-off traveling state is determined by changing the transition threshold based on a prediction result of how long the low-speed state will continue. Alternatively, the transition threshold of the same value may be used regardless of the prediction result of how long the low-speed state will continue. In this case, instead of performing S505 and S506 in FIG. 5, it may be determined that the control device 2 transitions from the hands-on traveling state to the hands-off traveling state, based on the prediction result of how long the low-speed state will continue exceeding a predetermined threshold. The prediction result exceeding the predetermined threshold may denote that the predicted duration time in the low-speed state exceeds a predetermined threshold time (for example, 15 minutes) or that the predicted duration time in the low-speed state exceeds a predetermined threshold distance (for example, 2 km).

In the above-described embodiments, whether to transition from the hands-on traveling state to the hands-off traveling state is determined based on the prediction result of how long the low-speed state will continue. Alternatively or additionally, whether to transition from the hands-off traveling state to the eye-off traveling state may also be determined based on the prediction result of how long the low-speed state will continue.

### SUMMARY OF EMBODIMENTS

<Item 1> A control device (2) for a vehicle (1), the control device comprising:
a recognition unit (201) configured to recognize an environment around the vehicle;
a travel control unit (202) configured to control traveling of the vehicle based on the environment recognized by the recognition unit; and
a prediction unit (203) configured to predict how long a low-speed state in which a speed of the vehicle is lower than a low-speed threshold will continue, wherein
the travel control unit determines, based on a prediction result by the prediction unit, whether to transition from a first traveling state to a second traveling state, a driver of the vehicle being less involved in the second traveling state than in the first traveling state.
According to this item, in a case where the low-speed state continues only for a short period of time, it becomes possible not to transition to the second traveling state, and thus an excessive change in the traveling state of the vehicle can be suppressed.
   <Item 2> The control device according to Item 1, wherein the prediction unit predicts how long the low-speed state will continue, based on a road structure (302) in an advancing direction of the vehicle.
According to this item, the degree of continuation of the low-speed state can be determined based on the road structure.
   <Item 3> The control device according to Item 1 or 2, wherein the prediction unit predicts how long the low-speed state will continue, based on a traffic situation in a past in an advancing direction of the vehicle.
According to this item, the degree of continuation of the low-speed state can be determined based on the traffic situation in the past.
   <Item 4> The control device according to any one of Items 1-3, further comprising
a threshold value determination unit (204) configured to determine a transition threshold based on a prediction result by the prediction unit, wherein
the travel control unit determines to transition from the first traveling state to the second traveling state based on the speed of the vehicle having become lower than the transition threshold.
According to this item, whether to transition can be determined in association with the vehicle speed.
   <Item 5> The control device according to any one of Items 1-4, wherein the travel control unit controls the vehicle in the second traveling state to follow a preceding vehicle.
According to this item, the continuation of the low-speed state is predictable in accordance with the preceding vehicle.
   <Item 6> A vehicle (1) comprising the control device (2) according to any one of Items 1-5.
According to this item, the above items are achievable in the form of a vehicle.
   <Item 7> A non-transitory storage medium for storing a program that causes a computer to function as each unit of the control device according to Items 1-5.
According to this item, the above items are achievable in the form of a program.
   <Item 8> A method for controlling a vehicle (1), the method comprising:
recognizing an environment around the vehicle;
controlling traveling of the vehicle based on the environment that has been recognized; and
predicting how long a low-speed state in which a speed of the vehicle is lower than a low-speed threshold will continue, wherein
controlling the traveling includes determining, based on a prediction result in the predicting, whether to transition from a first traveling state to a second traveling state, a driver of the vehicle is less involved in the second traveling state than in the first traveling state.
According to this item, in a case where the low-speed state continues only for a short period of time, it becomes possible not to transition to the second traveling state, and thus an excessive change in the traveling state of the vehicle can be suppressed.

The invention is not limited to the foregoing embodiments, and various variations/changes are possible within the spirit of the invention.

What is claimed is:

1. A control device for a vehicle, the control device comprising:
a recognition unit configured to recognize an environment around the vehicle;
a travel control unit configured to control traveling of the vehicle based on the environment recognized by the recognition unit; and
a prediction unit configured to predict how long a low-speed state in which a speed of the vehicle is lower than a low-speed threshold will continue, wherein
the travel control unit determines, based on a prediction result by the prediction unit, whether to transition from a first traveling state to a second traveling state, a driver of the vehicle being less involved in the second traveling state than in the first traveling state.

2. The control device according to claim 1, wherein the prediction unit predicts how long the low-speed state will continue, based on a road structure in an advancing direction of the vehicle.

3. The control device according to claim 1, wherein the prediction unit predicts how long the low-speed state will continue, based on a traffic situation in a past in an advancing direction of the vehicle.

4. The control device according to claim 1, further comprising
a threshold value determination unit configured to determine a transition threshold based on a prediction result by the prediction unit, wherein
the travel control unit determines to transition from the first traveling state to the second traveling state based on the speed of the vehicle having become lower than the transition threshold.

5. The control device according to claim 1, wherein the travel control unit controls the vehicle in the second traveling state to follow a preceding vehicle.

6. A vehicle comprising the control device according to claim 1.

7. A non-transitory storage medium for storing a program that causes a computer to function as each unit of the control device according to claim 1.

8. A method for controlling a vehicle, the method comprising:
recognizing an environment around the vehicle;
controlling traveling of the vehicle based on the environment that has been recognized; and
predicting how long a low-speed state in which a speed of the vehicle is lower than a low-speed threshold will continue, wherein
controlling the traveling includes determining, based on a prediction result in the predicting, whether to transition from a first traveling state to a second traveling state, a driver of the vehicle is less involved in the second traveling state than in the first traveling state.
